(19) United States
(12) Patent Application Publication
(10) Pub. No.: US 2025/0349013 A1
(43) Pub. Date: Nov. 13, 2025

(54) INFORMATION PROCESSING METHOD

(71) Applicant: TOYOTA JIDOSHA KABUSHIKI KAISHA, Toyota-shi, (JP)

(72) Inventor: Mitsuhiro MABUCHI, Tokyo (JP)

(73) Assignee: TOYOTA JIDOSHA KABUSHIKI KAISHA, Toyota-shi, (JP)

(21) Appl. No.: 19/036,610

(22) Filed: Jan. 24, 2025

(30) Foreign Application Priority Data
May 13, 2024 (JP) 2024-078048

(51) Int. Cl. G06T 7/11

(52) U.S. Cl. CPC G06T 7/11; G06T 2207/20081

(57) ABSTRACT

A learning model includes a plurality of first models and a second model different from the first models. An information processing method includes: a dividing step of dividing an image to be used for training of a learning model into a plurality of patches; a first input step of inputting the patches to a plurality of first models without overlapping; an adding step of adding noise to each of a plurality of calculation results output from the first models; and a second input step of inputting, to a second model, a plurality of calculation results to each of which the noise has been added.

### CROSS-REFERENCE TO RELATED APPLICATION

This application claims priority to Japanese Patent Application No. 2024-078048 filed on May 13, 2014, incorporated herein by reference in its entirety.

### BACKGROUND

### 1. Technical Field

The present disclosure relates to the technical field of information processing methods.

### 2. Description of Related Art

For example, a method in which a neural network that is a learning model is divided into a plurality of neural networks to allow privacy protection in training of the learning model has been proposed as an information processing method (see Japanese Unexamined Patent Application Publication No. 2024-030614 (JP 2024-030614 A)).

### SUMMARY

The technique described in JP 2024-030614 A has room for improvement.

The present disclosure was made in view of the above circumstances, and an object of the present disclosure is to provide an information processing method that allows privacy protection in training of a learning model.

An information processing method according to an aspect of the present disclosure includes:
a dividing step of dividing an image to be used for training of a learning model into a plurality of patches, the learning model being composed of a plurality of first models and a second model different from the first models;
a first input step of inputting the patches to the first models without overlapping; an adding step of adding noise to each of a plurality of calculation results output from the first models; and a second input step of inputting, to the second model, the calculation results to each of which the noise has been added.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an information processing system;

FIG. 2 is a diagram illustrating a flow of data of an information processing system and a configuration example of a learning model;

FIG. 3A is a diagram showing the main part of the flow of the information processing system during training;

FIG. 3B is a diagram showing the main part of the data flow of the information processing system during inference;

FIG. 4A is a diagram illustrating a specific example of a noise calculation method;

FIG. 4B is a diagram illustrating a specific example of the noise calculation method;

FIG. 4C is a diagram illustrating a specific example of the noise calculation method;

FIG. 5A is a flowchart showing an example of an information processing method during training;

FIG. 5B is a flowchart showing an example of an information processing method during inference;

FIG. 6A is a diagram showing a main part of the flow of the information processing system during training; and

FIG. 6B is a diagram showing a main part of the data flow of the information processing system during inference.

### DETAILED DESCRIPTION OF EMBODIMENTS

### First Embodiment

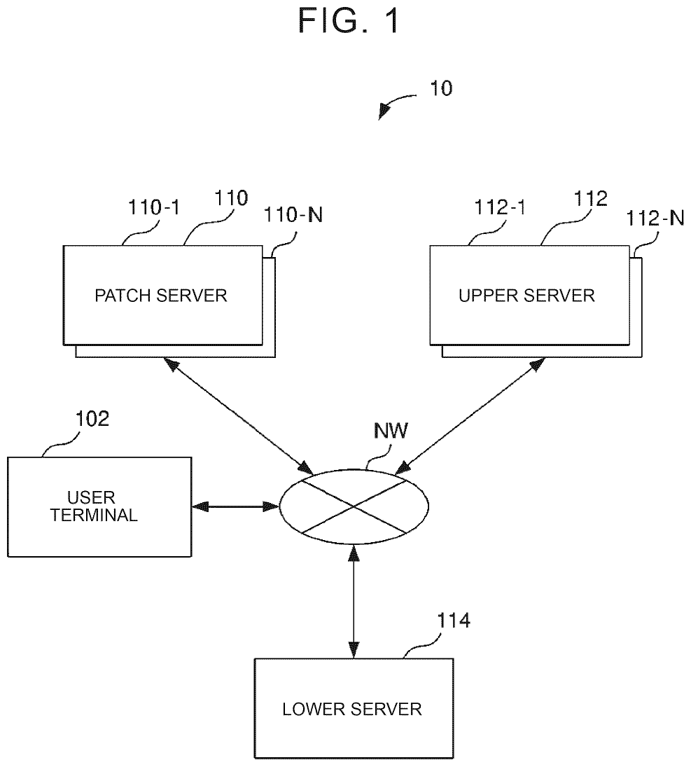

A first embodiment of an information processing method will be described with reference to FIGS. 1 to 5B. First, an information processing method related to deep learning of image recognition will be described. In the present embodiment, an image used for training is divided into a plurality of patches. In the present embodiment, a patch-partitioned neural network (Patch Split Neural Network) is used as a configuration of the training model. The training model may be, for example, a model in which CNN (Convolutional Neural Network) is divided into two models, namely an Upper model and a Lower model.

In FIG. 1, the information processing system 10 includes a user terminal 102, a plurality of patch servers 110 (110-N from 110-1), a plurality of Upper servers 112 (112-N from 112-1) that store a plurality of Upper models, respectively, and a Lower server 114 that stores a Lower model. The user terminal 102, the plurality of patch servers 110, the plurality of Upper servers 112, and Lower server 114 are connected via a networked NW.

The user terminal 102 is a terminal used for inputting an image used for training. The patch server 110 is a storage server for storing a plurality of patches generated by dividing an image input using the user terminal 102. Upper server 112 and Lower server 114 are servers that store Upper models and Lower model as training models, respectively.

The user terminal 102 may be realized by a computer such as a personal computer. The user terminal 102 may include a computing device, a storage device, and a communication interface. An example of the computing device is either or both of CPU (Central Processing Unit) and GPU (Graphics Processing Unit). An example of the storage device is at least one of the following: RAM (Random Access Memory), ROM (Read Only Memory), hard disk drive, and SSD (Solid Sate Drive). The user terminal 102 may include either or both of an input device (for example, a keyboard, a mouse, a touch pad, etc.) and an output device (for example, a display, a speaker, etc.).

### Training

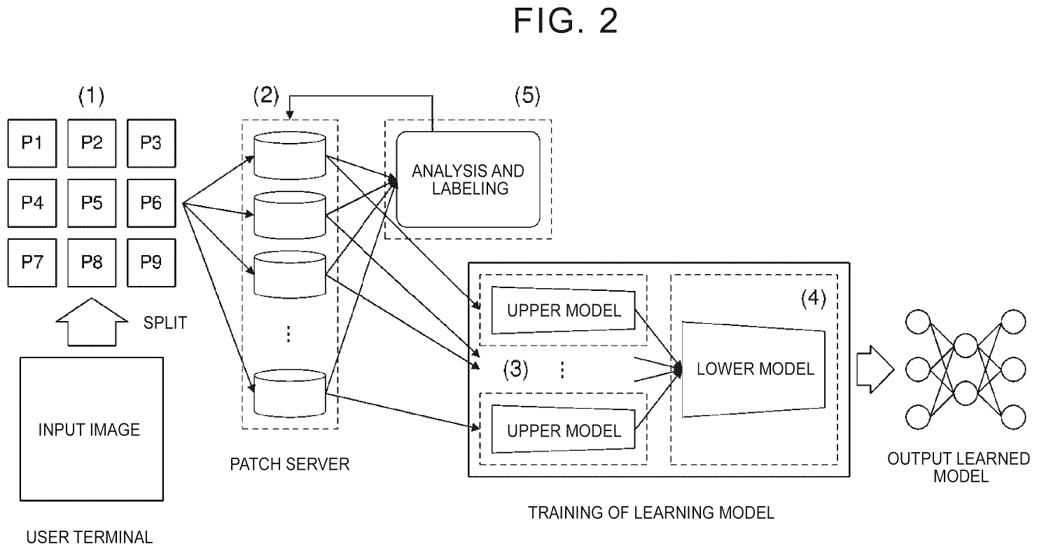

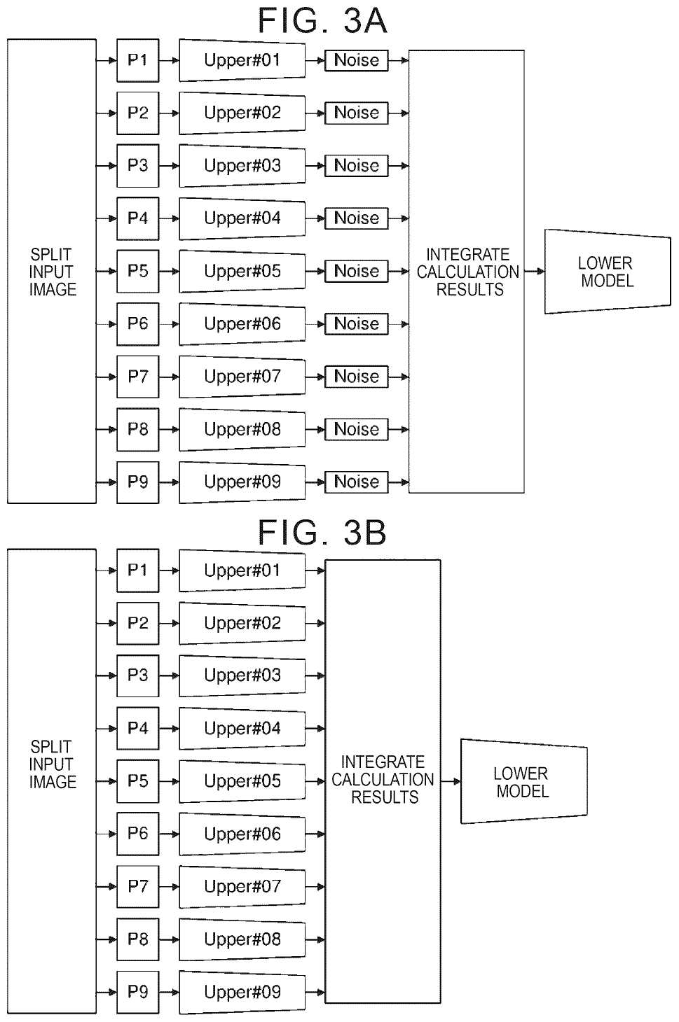

The flow of the information processing system 10 during training of the learning model will be described with reference to FIGS. 2, 3A, and 3B. In (1) of FIG. 2, the input image input by the user via the user terminal 102 is divided into a plurality of patches. In FIG. 2, the input image is divided into nine patches, but the number of divisions is not limited to nine. The input image may be divided by the user terminal 102. The input image may be divided by one patch server 110.

The division of the input image may be a simple division or an overlap division. In the simple division, the input image may be divided without duplication, for example, based on the size of the input image. For example, for an input image of 32×32 size, if the patch size is 16×16, the input image may be divided into four patches. For example, for an input image of 32×32 size, if the patch size is 8×8, the input image may be divided into 16 patches. In the overlap division, the input image may be divided by overlapping with a fixed length, for example. For example, for 32×32 sized incoming images, if the fixed length is 8 and the patch size is 16×16, it may be divided into nine patches. For example, for 32×32 sized incoming images, if the fixed length is 4 and the patch size is 8×8, it may be divided into 49 patches. Either the simple division or the overlap division may be selected according to the complexity of the input image.

In (2) of FIG. 2, a plurality of patches generated by dividing one input image is stored in separate patch servers 110. Each of the plurality of patches may be stored in a predetermined patch server 110. Only a patch corresponding to a predetermined position of the input image (for example, a patch P1 corresponding to a part of the upper left corner of the input image) may be stored in one patch server 110 out of the plurality of patch servers 110.

In (3) of FIG. 2, each of the plurality of patches is input to a predetermined Upper model. At this time, the plurality of patches is input to the plurality of Upper models without overlapping (in other words, so that two or more patches are not input to one Upper model). For example, as shown in FIG. 3A, P1 corresponding to the upper left corner of the input images may be input to “Upper #01” as an Upper model. For example, the patch P2 corresponding to the upper middle part of the input image may be input to “Upper #02” as an Upper model. As described above, Upper for which the patch is input may be determined in advance based on the position of the patch in the input images. Since the patches are input to Upper models, Upper models are trained. Here, the respective Upper models are activated and operated by independent Upper servers 112.

As shown in FIG. 3A, after Upper models are trained, noises are added to the calculation results of Upper models. The process of adding noises to the calculation results of the Upper models may be performed by each Upper server 112. As an example of the calculation result of Upper, the characteristic amount according to the patch is exemplified.

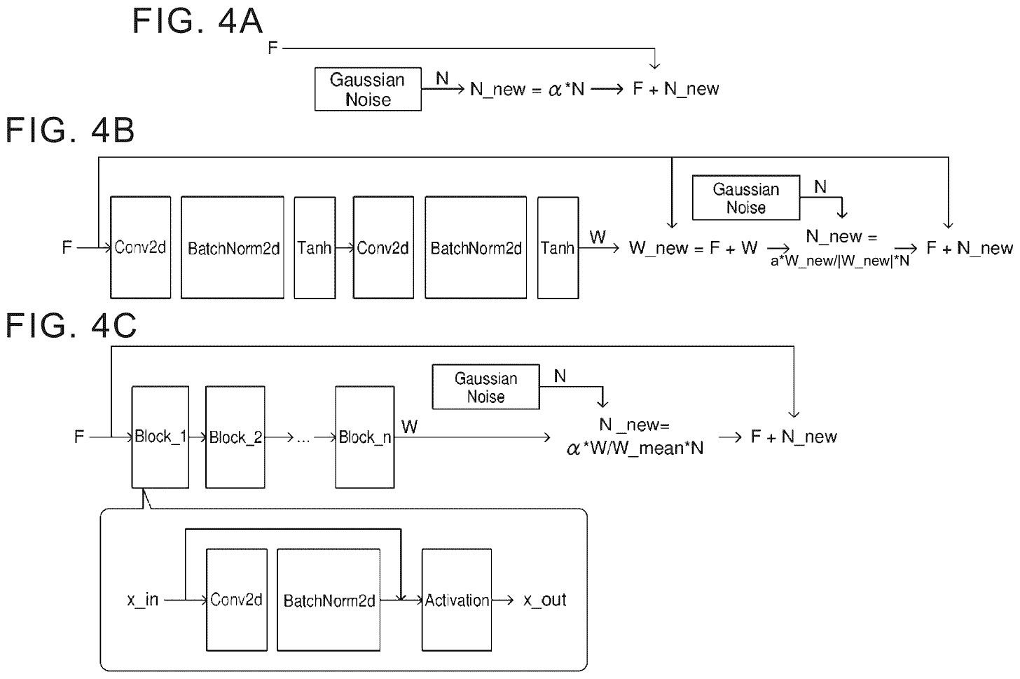

An example of the noise that is added to the calculation results of Upper models will be described with reference to FIGS. 4A to 4C. In FIGS. 4A to 4C, “F” represents the calculation results of the Upper models. In FIG. 4B, “Conv2d”, “BatchNorm2d”, and “Tanh” represent “two-dimensional convolution layer”, “regularization layer”, and “activation function”, respectively. The activation function is not limited to “Tanh”, and may be, for example, a sigmoid function or a ReLU (Rectified Linear Unit). In FIG. 4B, “Conv2d”, “BatchNorm2d” and “Tanh” represent one neuron in a neural network. In FIG. 4C, “Activation” represents “activation function”. In FIG. 4C, “Block_1”, “Block_2”, . . . , “Block_n” represents one neuron in the neural network.

For example, in the method shown in FIG. 4A, the product N_new (i.e., α*N) of the Gaussian noise N and the coefficient α may be added as noise to the calculation result F. The Gaussian noise may be referred to as white noise. For example, in the method shown in FIG. 4B, the calculation result F may be input to the neural network. The sum W_new (i.e., F+W) of the output W of the neural network and the calculation result F may be calculated. The product N_new (i.e., α*W_new/|W_new|*N) of the Gaussian noise N and the coefficient “α*W_new/|W_new|” may be added to the calculation result F as the noise.

For example, in the method shown in FIG. 4C, the calculation result F may be input to the neural network. The product N_new (i.e., α*W/W_mean*N) of the Gaussian noise N and the coefficient “α*W/W_mean” including the output W of the neural network may be added to the calculation result F as the noise. Each neuron of the neural network (see “Block” in FIG. 4C) may have a two-dimensional convolutional layer (e.g., Conv2d), a regularization layer (e.g., BatchNorm2d), and an activation function. The input x_in of each neuron may be input to a two-dimensional convolutional layer. The sum of the output of the regularization layer and the input x_in may be input to the activation function. The activation function may output the output x_out. In the case of Block_1, the input x_in is the calculation result F. In the case of Block_n, the output x_out is the output W of the neural network. For example, the activation function of Block_1 to Block_(n−1) may be a Mish function, and the activation function of Block_n may be a sigmoid function. Note that the activation function is not limited to Mish function and the sigmoid function, and other activation functions can be applied. The numbers of neurons in the neural network shown in FIG. 4C may be any desired number.

It should be noted that the noise added to the calculation results of the Upper models is not limited to the noise calculated by the method described with reference to FIGS. 4A to 4C, and may be the noise calculated by another method. It should be noted that any random noise can be applied to the noise added to the calculation results of the Upper models, instead of Gaussian noise. Note that the configuration of the neurons of the neural network is not limited to the configuration shown in FIGS. 4B and 4C. For example, the neuron may have a pooling layer between the two-dimensional convolutional layer and the regularization layer. For example, a neuron may have two or more two-dimensional convolutional layers. For example, a neuron may have two or more sets of two-dimensional convolutional layers and pooling layers.

Referring back to FIG. 2, after the calculation results of the respective Upper models to which the noises are added are integrated (see FIG. 3A), the integrated calculation result of the Upper models is input to Lower model. It should be noted that the process of integrating the calculation results with noise added thereto may be performed by Lower server 114. In the Lower model, a calculation based on the integrated calculation result of the Upper models is performed. As a result, the recognition result of the learning model is obtained. For example, the learning model may be evaluated by calculating a loss associated with the calculation result of the Lower model. In this way, the information processing system 10 generates and outputs a learned model.

In (5) of FIG. 2, necessary patches may be collected according to the learning state of the learned learning model. The input image may be restored from the collected patches. By analyzing the restored input image, correct answer data may be labeled to the patch as appropriate. Note that this processing is arbitrary and may not be performed.

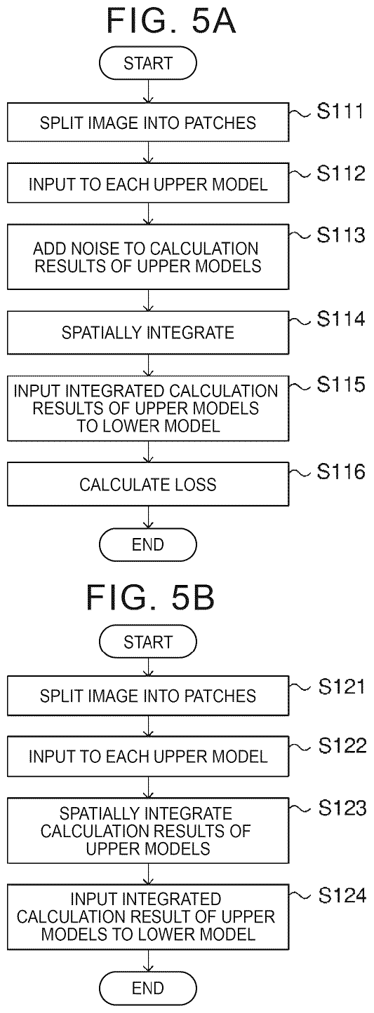

The operation of the information processing system 10 during training of the learning model will be described referring to the flowchart of FIG. 5A. In FIG. 5A, the user terminal 102 divides the input images into a plurality of patches (S111). The user terminal 102 transmits a plurality of patches to a predetermined plurality of patch servers 110. After that, a plurality of patches generated by dividing one input image are input to a predetermined Upper model (S112). As a result, the calculation results are output from the Upper models. For example, each of the plurality of Upper servers 112 adds noise to the calculation results of the Upper models (S113). Each of the plurality of Upper servers 112 sends the calculation results with noise added thereto to the Lower server 114.

Lower server 114 may integrate the calculation results of the Upper models (S114). Lower server 114 inputs the integrated calculation result of the Upper models to Lower model (S115). In the Lower model, a calculation based on the integrated calculation result of the Upper models is performed. As a result, the recognition result of the learning model is obtained. For example, Lower server 114 calculates loss associated with the calculation result of the Lower model (S116). In the information processing system 10, for example, the weight parameters of each of the plurality of Upper models and Lower model may be adjusted based on the calculated loss.

### Inference

An information processing method related to image recognition using a learned model generated by the information processing method related to deep learning of image recognition described above will be described. The learned model includes a plurality of learned Upper models and a learned Lower model.

In the information processing system 10, a plurality of learned Upper models and a learned Lower model may be used to recognize (for example, infer) images. Here, the flow of the data of the information processing system 10 during inference of an unknown image (that is, an image not used for training of the learning model) will be described with reference to FIG. 3B.

In FIG. 3B, the input image input by the user via the user terminal 102 is divided into a plurality of patches. In FIG. 3B, the input image is divided into nine patches, but the number of divisions is not limited to nine. The plurality of patches is input to a predetermined Upper model. For example, the patch P1 corresponding to the upper left corner of the input image may be input to “Upper #01” as an Upper model during training. In this case, the patch P1 corresponding to the upper left corner of the unknown images may be input to “Upper #01” as a learned Upper model trained using the patch P1.

As a result, a plurality of calculation results corresponding to the plurality of patches is output from the plurality of learned Upper models. After the calculation results of the respective learned Upper models are integrated, the integrated calculation result is input into Lower model. Lower server 114 inputs the integrated calculation result to the learned Lower model. As a result, the recognition result of the input image by the learned model is obtained. At the time of inference, noise is not added to the calculation results of the learned Upper models.

The operation of the information processing system 10 at the time of inference of unknown images will be described referring to the flowchart of FIG. 5B. In FIG. 5B, the user terminal 102 divides the input images into a plurality of patches (S121). The user terminal 102 inputs a plurality of patches to a predetermined learned Upper models (S122). As a result, a plurality of calculation results corresponding to the plurality of patches is output from the plurality of learned Upper models. The upper servers 112 send the plurality of calculation results to the Lower server 114. Lower server 114 may spatially integrate the plurality of calculation results (S123). Lower server 114 inputs the integrated calculation result to the Lower model (S124). As a result, the recognition result of the input image by the learned model is obtained.

### Technical Effect

For example, data including personal information such as a face image may be used to train a learning model related to image recognition. On the other hand, laws concerning privacy-protection such as GDPR (General Data Protection Regulation) and CCPA (California Consumer Privacy Act) have been enacted in various countries. Privacy protection is becoming important in data collection and model learning.

For example, in association learning, privacy protection is realized by not collecting data centrally. However, when it is desired to improve the performance of the model, there is a problem that the data cannot be adjusted. In addition, in order to protect privacy, a method of applying a mask to a portion including personal information such as a face or the like is also conceivable, but there is a high possibility that the recognition performance of the model is affected.

On the other hand, in the information processing system 10, the input image is divided into a plurality of patches during training of the learning model. Since the size of the patch is smaller than the size of the input image, it is extremely difficult to identify the privacy information from the patch even if the privacy information is included in the input image. That is, by dividing the input image into a plurality of patches, each patch can be made non-privacy information.

Further, when training a neural network in deep learning of image recognition, a large amount of images is required as learning data. In addition, in the case of supervised learning, it is necessary to assign a label of correct answer data to an image after image acquisition. The collected image may include information related to privacy, such as a face, a license plate of a vehicle, or the like. When the collected images are stored in one place, it is necessary to be careful with handling them even if security is secured.

On the other hand, in the information processing system 10, a plurality of patches generated by dividing one input image is stored in separate patch servers 110. Therefore, the privacy information is not restored unless a plurality of patches related to one input image are extracted from each of the plurality of patch servers 110. Note that part of users may be permitted to retrieve a plurality of patches related to one input image from the plurality of patch servers 110. With this configuration, it is possible to verify the learning model using one input image restored from a plurality of patches.

Incidentally, in the information processing system 10, a method of dividing a neural network is used. For example, in the Lower model, the calculation results of Upper models (for example, the features related to the patches) are input, while the patch is not input. As described above, in the divided neural network, consideration for privacy protection is possible. However, a method of restoring original data from data in the middle of calculation (for example, calculation result of Upper model input to Lower model) has been studied.

In contrast, in the information processing system 10, noises are added to the calculation results of Upper models during training of the learning model. Therefore, the information processing system 10 can easily restore the original data from the data input to the Lower model (i.e., the calculation results with noise added thereto). In addition, according to studies of the present inventors, it has been found that generalization performance of a learned model is improved by adding noise to the calculation results of the Upper models. That is, according to the information processing system 10, it is possible to improve the performance of the learned model.

As described above, the information processing system 10 allows privacy protection in training of the learning model.

### SECOND EMBODIMENT

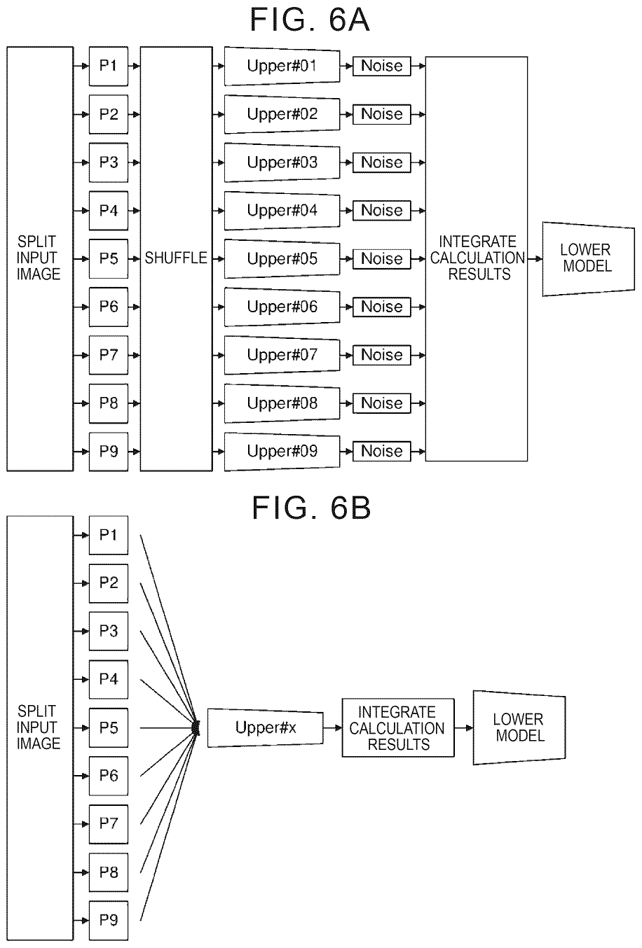

A second embodiment according to the information processing methods will be described with reference to FIGS. 6A and 6B in addition to FIGS. 1 and 2. The second embodiment is the same as the first embodiment described above except that a part of the information processing method is different. Therefore, the description of the second embodiment that overlaps with the description of the first embodiment will be omitted as appropriate.

### Training

As shown in FIG. 6A, prior to each of the plurality of patches being input to Upper model, a plurality of patches generated by dividing one input image and a plurality of Upper models to which the plurality of patches are input may be randomly (in other words, at random) determined. At this time, a combination of a plurality of patches and a plurality of Upper models is determined so that two or more patches are not input to one Upper model. In (3) of FIG. 2, a plurality of patches is input to a plurality of Upper models according to the combination determined as described above. Consequently, Upper model-based training is performed.

As shown in FIG. 6A, after Upper models are trained, noise is added to the calculation results of Upper models. Then, as shown in FIG. 6A, the calculation results of the Upper models to each of which noise has been added are integrated. In this case, the calculation results of the Upper models are spatially integrated based on the combination determined as described above and the position of each of the patches in one input image. For example, for a plurality of patch P1 to P9, the calculation results of the Upper models are integrated so as to reproduce the positional relation of P9 from the plurality of patch P1, which corresponds to the calculation result of each Upper model being spatially integrated. The integrated calculation result of Upper models is then input to Lower model.

An operation of the information processing system 10 according to the second embodiment will be described. In the information processing system 10 according to the second embodiment, after the processing of S111 in FIG. 5A, a combination of a plurality of patches generated by dividing one input image and a plurality of Upper models to which the plurality of patches is respectively input is randomly determined prior to the processing of S112. Note that this process may be performed, for example, by the user terminal 102, one patch server 110, or one Upper server 112. Note that information indicating a combination of a plurality of patches and a plurality of Upper servers is sent to Lower server 114.

In S112 of FIG. 5A, a plurality of patches generated by dividing one input image are input to Upper of a plurality of corresponding Upper servers 112 according to the combination determined as described above. As a result, the calculation results are output from the Upper models.

In S114 of FIG. 5A, Lower server 114 spatially integrates the calculation results of the Upper models based on information indicating a combination of the plurality of patches and the plurality of Upper servers and a position of each of the plurality of patches in one input image. Lower server 114 then inputs the integrated calculation result of the Upper models to Lower model (S115). In the Lower model, a calculation based on the integrated calculation result of the Upper models is performed. As a result, the recognition result of the learning model is obtained.

### Inference

An information processing method related to image recognition using a learned model generated by the information processing method related to deep learning of image recognition described above will be described.

In the second embodiment, one learned Upper model may be selected from a plurality of learned Upper models. For example, images for evaluation (so-called test data) may be input to each of the plurality of learned Upper models. A plurality of learned Upper models may be evaluated based on the calculation results of the plurality of learned Upper models. For example, the learned Upper model with the highest evaluation may be selected as the one learned Upper model.

In the second embodiment, as shown in FIG. 6B, the selected one learned Upper model (see “Upper #x” in FIG. 6B) and Lower model may be used for image-recognition (for example, inference). In a second embodiment, as shown in FIG. 6B, a plurality of patches is input to the selected one learned Upper model. In this case, a plurality calculation results corresponding to the plurality of patches is output from one learned Upper model.

### Technical Effect

The information processing system 10 according to the second embodiment enables privacy protection in training of the learning model as in the first embodiment described above.

In the above-described first embodiment, during training of the learning model, patches corresponding to particular positions in the input images are constantly input to one Upper model. In this case, one learned Upper model tends to have a higher accuracy of the calculation result of the patch corresponding to the specific position, while a lower accuracy of the calculation result of the patch corresponding to the position other than the specific position in the input image. Therefore, when an unknown picture is inferred, it is difficult to obtain the recognition result of the expected accuracy unless all of the plurality of learned Upper models included in the learned model are used.

On the other hand, in the second embodiment, during training of the learning model, a plurality of patches and a plurality of Upper models to which the plurality of patches are respectively input are randomly determined. When a patch corresponding to an arbitrary position in the input images is input to one Upper model during training, the accuracy of the calculation result of one learned Upper model is less affected by the input patch. Therefore, even if only one learned Upper model among the plurality of learned Upper models is used at the time of inferring unknown images, the expected accuracy can be recognized.

In the second embodiment, the unknown images are inferred using the selected one learned Upper model and the learned Lower model. As a result, it is possible to infer the unknown images using the plurality of learned Upper models and the learned Lower model. Further, the present inventors have found that the accuracy of the recognition result in the case where the inference of the unknown image is performed using the selected one learned Upper model and the learned Lower model is equal to or more than the accuracy of the recognition result in the case where the inference of the unknown image is performed using the plurality of learned Upper models and the learned Lower model.

Aspects of the disclosure derived from the above-described embodiments are described below.

In the information processing method according to an aspect of the disclosure, the learning model includes a plurality of first models and a second model different from the plurality of first models. The information processing method includes a dividing step, a first input step, an adding step, and a second input step. In the dividing step, an image used for training of the learning model is divided into a plurality of patches. In the first input step, the plurality of patches is input to the plurality of first models without overlapping. In the adding step, noise is added to each of the plurality of calculation results output from each of the plurality of first models. In the second input step, the plurality of calculation results to which noise is added are input to the second model. In the above-described embodiment, the “Upper model” corresponds to an example of the “first model”, and the “Lower model” corresponds to an example of the “second model”.

In the information processing method, in the first input step, the plurality of patches may be input to the plurality of first models randomly without overlapping. In this aspect, in the second input step, after the plurality of calculation results to which noise is added are integrated on the basis of information indicating a correspondence relationship between the positions of the plurality of patches in the image and the first model to which each of the plurality of patches is input, the integrated result of the plurality of calculation results to which noise is added may be input to the second model. In the information processing method, the noise may be Gaussian noise.

The present disclosure is not limited to the above-described embodiments, and can be modified as appropriate within the scope and spirit of the disclosure that can be read from the claims and the entire specification, and an information processing method accompanied by such a modification is also included in the technical scope of the present disclosure.

What is claimed is:

1. An information processing method comprising:
a dividing step of dividing an image to be used for training of a learning model into a plurality of patches, the learning model being composed of a plurality of first models and a second model different from the first models;
a first input step of inputting the patches to the first models without overlapping;
an adding step of adding noise to each of a plurality of calculation results output from the first models; and
a second input step of inputting, to the second model, the calculation results to each of which the noise has been added.

2. The information processing method according to claim 1, wherein, in the first input step, the patches are input to the first models randomly without overlapping.

3. The information processing method according to claim 2, wherein, in the second input step, the calculation results to each of which the noise has been added are integrated based on information indicating a correspondence between positions of the patches in the image and the first models to which the patches have been input, and then an integration result of the calculation results to each of which the noise has been added is input to the second model.

4. The information processing method according to claim 1, wherein the noise is Gaussian noise.
